(19) United States
(12) Patent Application Publication
(10) Pub. No.: US 2026/0155353 A1
(43) Pub. Date: Jun. 4, 2026

(54) METHOD FOR PRODUCING POSITIVE ELECTRODE, POSITIVE ELECTRODE, AND LITHIUM METAL SECONDARY BATTERY

(71) Applicant: HONDA MOTOR CO., LTD., Tokyo (JP)

(72) Inventors: Tetsuo KATO, Saitama (JP); Akihisa TANAKA, Saitama (JP); Toshiyuki ARIGA, Saitama (JP); Takeshi FUJINO, Saitama (JP)

(21) Appl. No.: 19/404,019

(22) Filed: Dec. 1, 2025

(30) Foreign Application Priority Data
Dec. 2, 2024 (JP) 2024-209328

(51) Int. Cl. H01M 4/1391; H01M 4/02; H01M 4/04; H01M 4/131; H01M 4/505; H01M 4/525; H01M 4/62; H01M 10/052

(52) U.S. Cl. CPC H01M 4/1391; H01M 4/0404; H01M 4/131; H01M 4/505; H01M 4/525; H01M 4/621; H01M 4/624; H01M 10/052; H01M 2004/021; H01M 2004/028

(57) ABSTRACT

A method for producing a positive electrode is provided. The method includes: mixing a positive electrode active material and a solution of a binder to produce a coating liquid; and applying the coating liquid to a positive electrode current collector to form a positive electrode material mixture layer. The positive electrode active material comprises single particles having a Ni content of 80 at. % or more. An amount of moisture contained in the solution of the binder is 280 ppm by mass or less. A ratio of the binder to a solid content contained in the coating liquid is 1 mass % or less. An amount of moisture contained in the positive electrode material mixture layer is 200 μg/cm³ or less.

This application is based on and claims the benefit of priority from Japanese Patent Application No. 2024-209328, filed on 2 Dec. 2024, the content of which is incorporated herein by reference.

### BACKGROUND OF THE INVENTION

### Field of the Invention

The present invention relates to a method for producing a positive electrode, a positive electrode, and a lithium metal secondary battery.

### Related Art

In recent years, research and development has been conducted on lithium metal secondary batteries that contribute to energy efficiency in order to ensure that more people have access to affordable, reliable, sustainable, and advanced energy.

Japanese Unexamined Patent Application, Publication No. 2022-508147 discloses a positive electrode including a positive electrode current collector and a positive electrode active material layer formed on the positive electrode current collector. Here, the positive electrode active material layer includes a binder and a positive electrode material having a bimodal particle size distribution including large particle diameter particles and small particle diameter particles having different average particle diameters (D₅₀). The large particle diameter particle is a lithium composite transition metal oxide having a nickel content of 80 atomic % or more among all transition metals. The small particle diameter particle is a lithium composite transition metal oxide containing nickel, cobalt, and aluminum, having a nickel content of 80 atomic % to 85 atomic % among all transition metals, and having an atomic ratio of cobalt to aluminum (Co/Al) of 1.5 to 5.

Japanese Unexamined Patent Application, Publication No. 2017-188445 discloses, as a positive electrode active material for a non-aqueous electrolyte secondary battery, lithium transition metal composite oxide single particles having a 50% particle diameter D₅₀ in a cumulative particle size distribution on a volume basis of 1 μm or more and 21 μm or less. Here, the positive electrode for a non-aqueous electrolyte secondary battery includes a current collector and a positive electrode active material layer disposed on the current collector and including a positive electrode active material for a non-aqueous electrolyte secondary battery and a binder.
Patent Document 1: Japanese Unexamined Patent Application, Publication No. 2022-508147
Patent Document 2: Japanese Unexamined Patent Application, Publication No. 2017-188445

### SUMMARY OF THE INVENTION

However, the large particle diameter particles and the small particle diameter particles disclosed in Japanese Unexamined Patent Application, Publication No. 2022-508147 are lithium composite transition metal oxides having a nickel content of 80 atomic % or more among all transition metals, and therefore contain residual alkali as an impurity and are prone to absorbing moisture. As a result, when the positive electrode is produced, the binder is likely to aggregate, and thus the peel strength of the positive electrode is likely to decrease. At this time, when the content of the binder in the positive electrode active material layer is increased in order to maintain the peel strength of the positive electrode, the content of the positive electrode material in the positive electrode active material layer is decreased, and the volume resistivity of the positive electrode is increased. In addition, the energy density of the positive electrode is lowered.

The lithium transition metal composite oxide single particles disclosed in Japanese Unexamined Patent Application, Publication No. 2017-188445 have a large specific surface area and therefore easily adsorb moisture. Therefore, when the lithium transition metal composite oxide single particles disclosed in Japanese Unexamined Patent Application, Publication No. 2017-188445 are applied to a lithium metal secondary battery, gas is likely to be generated associated with charging and discharging, and the capacity retention ratio is likely to decrease.

An object of the present invention is to provide a method for producing a positive electrode and a positive electrode capable of maintaining peel strength even when the content of a binder is small, suppressing generation of gas associated with charging and discharging of a lithium metal secondary battery, improving the capacity retention ratio of the lithium metal secondary battery, and reducing the volume resistivity.

A first aspect of the present invention is a method for producing a positive electrode. The method includes: mixing a positive electrode active material and a solution of a binder to produce a coating liquid; and applying the coating liquid to a positive electrode current collector to form a positive electrode material mixture layer. The positive electrode active material includes single particles having a Ni content of 80 at. % or more. An amount of moisture contained in the solution of the binder is 280 ppm by mass or less. A ratio of the binder to a solid content contained in the coating liquid is 1 mass % or less. An amount of moisture contained in the positive electrode material mixture layer is 200 μg/cm³ or less.

In a second aspect of the present invention according to the first aspect, the positive electrode active material includes first single particles having a volume-based median diameter D₅₀ of 3 μm or more and 5.5 μm or less.

In a third aspect of the present invention according to the second aspect, the positive electrode active material further includes second single particles having a volume-based median diameter D₅₀ of 0.5 μm or more and 2.5 μm or less.

In a fourth aspect of the present invention according to the third aspect, in the positive electrode active material, a mass ratio of the second single particles to the first single particles is 1/9 or more and 3/2 or less.

In a fifth aspect of the present invention according to any one of the first to fourth aspects, the ratio of the binder to the solid content contained in the coating liquid is 0.5 mass % or more and 0.8 mass % or less.

In a sixth aspect of the present invention according to any one of the first to fifth aspects, when producing the coating liquid, a conductivity aid is further mixed therein. A ratio of the conductivity aid to the solid content contained in the coating liquid is 2.5 mass % or less.

In a seventh aspect of the present invention according to the sixth aspect, the ratio of the conductivity aid to the solid content contained in the coating liquid is 2.0 mass % or less.

An eighth aspect of the present invention is a positive electrode. The positive electrode includes: a positive electrode current collector; and a positive electrode material mixture layer formed on the positive electrode current collector. The positive electrode material mixture layer includes a positive electrode active material and a binder, and a content of the binder is 1 mass % or less. The positive electrode active material includes single particles having a Ni content of 80 at. % or more. An amount of moisture contained in the positive electrode material mixture layer is 200 μg/cm³ or less.

In a ninth aspect of the present invention according to the eighth aspect, the positive electrode material mixture layer has no pores having a major axis of 3 μm or more.

In a tenth aspect of the present invention according to the eighth or ninth aspect, the positive electrode material mixture layer further includes a conductivity aid, has a content of the conductivity aid of 2.5 mass % or less, and has a density of 3.2 g/cm³ or more and 3.6 g/cm³ or less. The positive electrode has a volume resistivity of 5.0 Ω·cm or less.

In an eleventh aspect of the present invention according to the tenth aspect, the positive electrode material mixture layer has a content of the conductivity aid of 2.0 mass % or less.

In a twelfth aspect of the present invention according to the eleventh aspect, the positive electrode active material includes first single particles having a volume-based median diameter D₅₀ of 3 μm or more and 5.5 μm or less and second single particles having a volume-based median diameter D₅₀ of 0.5 μm or more and 2.5 μm or less.

In a thirteenth aspect of the present invention according to the twelfth aspect, in the positive electrode active material, a mass ratio of the second single particles to the first single particles is 1/9 or more and 3/2 or less.

A fourteenth aspect of the present invention is a lithium metal secondary battery including the positive electrode according to any one of the eighth to thirteenth aspects.

According to the present invention, it is possible to provide a method for producing a positive electrode and a positive electrode capable of maintaining peel strength even when the content of a binder is small, suppressing generation of gas associated with charging and discharging of a lithium metal secondary battery, improving the capacity retention ratio of the lithium metal secondary battery, and reducing the volume resistivity.

### DETAILED DESCRIPTION OF THE INVENTION

Hereinafter, an embodiment of the present invention will be described.

### [Method for Producing Positive Electrode]

The method for producing a positive electrode according to the present embodiment includes a step of mixing a positive electrode active material and a solution of a binder to produce a coating liquid, and a step of applying the coating liquid to a positive electrode current collector to form a positive electrode material mixture layer. The positive electrode active material includes single particles.

The content of Ni in the positive electrode active material is 80 at. % or more, and preferably 60 at. % or more. Since the content of Ni in the positive electrode active material is 80 at. % or more, when the positive electrode is applied to a lithium metal secondary battery, the initial capacity increases. The content of Ni in the positive electrode active material is, for example, 90 at. % or less.

The positive electrode active material is preferably a lithium transition metal composite oxide represented by general formula (1):

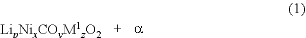

where p is 1.0 or more and 1.3 or less, x is 0.3 or more and 0.95 or less, y is 0 or more and 0.4 or less, z is 0 or more and 0.5 or less, the sum of x, y, and z is 1, x is −0.1 or more and 0.1 or less, and MI is Mn and/or Al.

The amount of moisture contained in the solution of the binder is 280 ppm by mass or less, and preferably 200 ppm by mass or less. Since the amount of moisture contained in the solution of the binder is 280 ppm by mass or less, adsorption of moisture to the positive electrode active material is suppressed, and the amount of moisture contained in the positive electrode material mixture layer decreases. As a result, since the binder is less likely to aggregate when the positive electrode is produced, the peel strength of the positive electrode is maintained even when the amount of the binder added is reduced. In addition, when the positive electrode is applied to a lithium metal secondary battery, generation of gas associated with charging and discharging is suppressed. It is presumed that this is because decomposition of the solvent contained in the electrolytic solution is suppressed. Further, when the positive electrode is applied to a lithium metal secondary battery, the capacity retention ratio is improved. It is presumed that this is because the generation of lithium hydroxide or lithium oxide due to the reaction between the lithium metal negative electrode and moisture is suppressed. The amount of moisture contained in the solution of the binder is, for example, 150 ppm or more.

The method of adjusting the amount of moisture contained in the solution of the binder to 280 ppm by mass or less is not particularly limited, and examples thereof include a method of producing the solution of the binder under a low dew point environment (e.g., an environment having a dew point of −40° C. or less).

The binder is not particularly limited, and examples thereof include polyvinylidene fluoride (PVDF).

The solvent contained in the solution of the binder is not particularly limited as long as it can dissolve the binder, and examples thereof include N-methyl-2-pyrrolidone (NMP).

The ratio of the binder to the solid content contained in the coating liquid is 1 mass % or less, and preferably 0.8 mass % or less. Since the ratio of the binder to the solid content contained in the coating liquid is 1 mass % or less, an increase in the amount of moisture contained in the positive electrode material mixture layer due to the binder is suppressed, and the volume resistivity of the positive electrode is lowered. The ratio of the binder to the solid content contained in the coating liquid is, for example, 0.5 mass % or more.

The amount of moisture contained in the positive electrode material mixture layer is 200 μg/cm³ or less, and preferably 150 μg/cm³ or less. Since the amount of moisture contained in the positive electrode material mixture layer is 200 μg/cm³ or less, when the positive electrode of the present embodiment is applied to a lithium metal secondary battery, generation of gas associated with charging and discharging is suppressed. Further, when the positive electrode of the present embodiment is applied to a lithium metal secondary battery, the capacity retention ratio is improved. The amount of moisture contained in the positive electrode material mixture layer is, for example, 100 μg/cm³ or more.

The method of adjusting the amount of moisture contained in the positive electrode material mixture layer to 200 μg/cm³ or less is not particularly limited, and examples thereof include a method for producing the coating liquid under a low dew point environment (e.g., an environment having a dew point of −40° C. or less), and a method of applying the coating liquid to the positive electrode current collector under a low dew point environment (e.g., an environment having a dew point of −40° C. or less).

The positive electrode active material preferably includes first single particles having a volume-based median diameter D₅₀ of 3 μm or more and 5.5 μm or less. This increases the filling ratio of the positive electrode material mixture layer. The positive electrode active material preferably further includes second single particles having a volume-based median diameter D₅₀ of 0.5 μm or more and 2.5 μm or less. This further increases the filling ratio of the positive electrode material mixture layer.

The mass ratio of the second single particles to the first single particles of the positive electrode active material is preferably 1/9 or more and 3/2 or less, and more preferably 3/7 or more and 2/3 or less. When the mass ratio of the second single particles to the first single particles of the positive electrode active material is 1/9 or more and 3/2 or less, the filling ratio of the positive electrode material mixture layer is further increased.

The specific surface area of the positive electrode active material is preferably 0.5 m²/g or more and 1.0 m²/g or less. When the specific surface area of the positive electrode active material is 0.5 m²/g or more, the load applied to make the positive electrode material mixture layer have a predetermined density becomes small, and the positive electrode active material is less likely to crack, so that the capacity retention ratio of the lithium metal secondary battery is improved. On the other hand, when the specific surface area of the positive electrode active material is 1.0 m²/g or less, since the positive electrode active material is less likely to aggregate, the uniformity of the thickness of the positive electrode material mixture layer is improved.

When producing the coating liquid, a conductivity aid may be further mixed therein. The conductivity aid is not particularly limited as long as it has electron conductivity, and examples thereof include carbon black and carbon nanotubes.

The ratio of the conductivity aid to the solid content contained in the coating liquid is preferably 2.5 mass % or less, and more preferably 2.0 mass % or less. When the ratio of the conductivity aid to the solid content contained in the coating liquid is 2.5 mass % or less, the peel strength of the positive electrode is increased. The ratio of the conductivity aid to the solid content contained in the coating liquid is, for example, 1 mass % or more.

The positive electrode current collector is not particularly limited, and examples thereof include an aluminum foil.

### [Positive Electrode]

In the positive electrode of the present embodiment, a positive electrode material mixture layer is formed on a positive electrode current collector, and the positive electrode material mixture layer includes a positive electrode active material and a binder. The positive electrode of the present embodiment is produced by the method for producing a positive electrode of the present embodiment.

The content of the binder in the positive electrode material mixture layer is 1 mass % or less, and preferably 0.8 mass % or less. Since the content of the binder in the positive electrode material mixture layer is 1 mass % or less, an increase in the amount of moisture contained in the positive electrode material mixture layer due to the binder is suppressed, and the volume resistivity of the positive electrode is lowered. The content of the binder in the positive electrode material mixture layer is, for example, 0.5 mass % or more.

The amount of moisture contained in the positive electrode material mixture layer is 200 μg/cm³ or less, and preferably 150 μg/cm³ or less. Since the amount of moisture contained in the positive electrode material mixture layer is 200 μg/cm³ or less, when the positive electrode of the present embodiment is applied to a lithium metal secondary battery, generation of gas associated with charging and discharging is suppressed. Further, when the positive electrode of the present embodiment is applied to a lithium metal secondary battery, the capacity retention ratio is improved. The amount of moisture contained in the positive electrode material mixture layer is, for example, 100 μg/cm³ or more.

The positive electrode material mixture layer preferably has no pores having a major axis of 3 μm or more. Pores are observed in an electron microscope image of a cross section of the positive electrode material mixture layer.

Here, when secondary particles are used as the positive electrode active material, cracks are likely to occur, and thus pores having a major axis of 3 μm or more are likely to exist in the positive electrode material mixture layer.

The density of the positive electrode material mixture layer is preferably 3.2 g/cm³ or more and 3.6 g/cm³ or less, and more preferably 3.3 g/cm³ or more and 3.5 g/cm³ or less. When the density of the positive electrode material mixture layer is 3.2 g/cm³ or more and 3.6 g/cm³ or less, occurrence of cracks in the positive electrode active material is suppressed, and as a result, pores having a major axis of 3 μm or more are less likely to exist in the positive electrode material mixture layer.

The positive electrode material mixture layer may further contain a conductivity aid. This lowers the volume resistivity of the positive electrode. At this time, the volume resistivity of the positive electrode is preferably 5.0 Ω·cm or less.

The content of the conductivity aid in the positive electrode material mixture layer is preferably 2.5 mass % or less, and more preferably 2.0 mass % or less. When the content of the conductivity aid in the positive electrode material mixture layer is 2.5 mass % or less, the peel strength of the positive electrode increases. The content of the conductivity aid in the positive electrode material mixture layer is, for example, 1 mass % or more.

### [Lithium Metal Secondary Battery]

The lithium metal secondary battery of the present embodiment includes the positive electrode of the present embodiment, a negative electrode, and a separator impregnated with an electrolytic solution.

In the negative electrode, a lithium metal layer is formed on a negative electrode current collector. The negative electrode current collector is not particularly limited, and examples thereof include a copper foil.

In the electrolytic solution, an electrolyte is dissolved in a non-aqueous solvent.

The electrolyte is not particularly limited, and examples thereof include lithium bis(fluorosulfonyl)imide (LiFSI).

The non-aqueous solvent is not particularly limited, and examples thereof include ether solvents such as 1,2-dimethoxyethane (DME) and 1,1,2,2-tetrafluoroethyl-2,2,3,3-tetrafluoropropyl ether (TTE).

Lithium difluoro (oxalate) borate (LiDFOB) may be added to the electrolytic solution. The content of LiDFOB in the electrolytic solution is not particularly limited, but is, for example, 0.2 mass % or more and 1.0 mass % or less.

The separator is not particularly limited, and examples thereof include a porous resin sheet. Examples of the resin constituting the porous resin sheet include polyethylene (PE), polypropylene (PP), polyester, cellulose, and polyamide.

The lithium metal secondary battery of the present embodiment may further include an outer casing material (e.g., a laminate film) that encases the positive electrode of the present embodiment, the negative electrode, and the separator impregnated with the electrolytic solution.

Although the embodiment of the present invention has been described above, the present invention is not limited to the above-described embodiment, and the above-described embodiment may be modified as appropriate within the scope of the gist of the present invention.

### EXAMPLES

Hereinafter, examples of the present invention will be described, but the present invention is not limited to the examples. Note that “parts” means parts by mass.

### (Amount of Moisture Contained in Solution of Binder)

Using a moisture meter AQ-2200 (manufactured by HIRANUMA), the amount of moisture contained in a solution of a binder was measured. At this time, the moisture contained in the solution of the binder was volatilized by a moisture vaporizer set at 150° C.

### (Amount of Moisture Contained in Positive Electrode Material Mixture Layer)

Using a moisture meter AQ-2200 (manufactured by HIRANUMA), the amount of moisture contained in the positive electrode material mixture layer was measured. At this time, the moisture contained in the positive electrode material mixture layer was volatilized by a moisture vaporizer set at 150° C.

### (Density of Positive Electrode Material Mixture Layer)

Using a Semi-Micro Analytical Balance GR-202 (manufactured by A&D Company, Limited) and a Stylus Type High-Precision Sensor Head GT2-P12K (manufactured by Keyence Corporation), the weight per unit area and the thickness of the positive electrode material mixture layer were measured, and the density of the positive electrode material mixture layer was calculated.

### (Crack of Positive Electrode Material Mixture Layer)

Using an electron microscope JSM-IT800 (manufactured by JEOL Ltd.), a cross-sectional image of the positive electrode material mixture layer was observed. The criteria for determining cracks in the positive electrode material mixture layer are as follows.
A: When there are no pores having a major axis of 3 μm or more.
B: When there are pores having a major axis of 3 μm or more.

### (Volume Resistivity of Positive Electrode)

Using an Electrode Resistance Measurement System RM2610 (manufactured by HIOKI E.E. Corporation), the volume resistivity of the positive electrode was measured.

### (Peel Strength of Positive Electrode)

Using a Digital Force Gauge ZTS-5N (manufactured by Imada Co., Ltd.) and a Standard Type Vertical Motorized Test Stand MX2-500N-L (manufactured by Imada Co., Ltd.), the load when the positive electrode was peeled off at 180° C. was measured and determined as the peel strength of the positive electrode.

### Example 1

A positive electrode was produced in the following manner in an environment having a dew point of −50° C.

Using HIVIS DISPER MIX Model 3D-2 (manufactured by PRIMIX Corporation), 19.15 g of polyvinylidene fluoride KF polymer #9700 (manufactured by KUREHA CORPORATION) as a binder was dissolved in 300.00 g of N-methyl-2-pyrrolidone (manufactured by Nippon Refine Co., Ltd.) as a solvent to obtain a 6 mass % solution of the binder. The amount of moisture contained in the solution of the binder was 264 ppm by mass.

Using a kneader HIVIS MIX Model 2P-03 (manufactured by PRIMIX Corporation) and a Thin-Film Spin System High-Speed Mixer FILMIX Model 56-30 (manufactured by PRIMIX Corporation), lithium nickel manganese cobalt oxide single particles having a Ni content of 84 at. % and a volume-based median diameter D₅₀ of 5 μm as a positive electrode active material, a dispersion liquid in which 12 mass % of acetylene black and 1 mass % of carbon nanotubes are dispersed as a dispersion liquid of a conductivity aid 1, and a solution of a binder were mixed so that the ratios of the binder and the conductivity aid 1 to the solid content contained in the coating liquid were 0.8 mass % and 3.0 mass %, respectively, to obtain a coating liquid.

The coating liquid was applied to an aluminum foil having a thickness of 12 μm and an electric conductivity of 3.37×10⁵ S/cm as a positive electrode current collector to form a positive electrode material mixture layer having a thickness of 65 μm, to obtain a positive electrode. The amount of moisture contained in the positive electrode material mixture layer was 157 μg/cm³, and the density of the positive electrode material mixture layer was 3.3 g/cm³.

### Example 2

A positive electrode was obtained in the same manner as in Example 1 except that a mixture of 70 mass % of lithium nickel manganese cobalt oxide single particles having a Ni content of 84 at. % and a volume-based median diameter D₅₀ of 5 μm and 30 mass % of lithium nickel manganese cobalt oxide single particles having a Ni content of 84 at. % and a volume-based median diameter D₅₀ of 2 μm was used as the positive electrode active material, and that the ratio of the conductivity aid 1 to the solid content contained in the coating liquid was 1.2 mass %. At this time, the amount of moisture contained in the solution of the binder was 278 ppm by mass. The amount of moisture contained in the positive electrode material mixture layer was 156 μg/cm³, and the density of the positive electrode material mixture layer was 3.5 g/cm³.

### Example 3

A positive electrode was obtained in the same manner as in Example 2 except that a dispersion liquid in which 3 mass % of acetylene black and 6 mass % of carbon nanotubes were dispersed was used as a dispersion liquid of a conductivity aid 2 instead of the conductivity aid 1, and that the ratio of the conductivity aid 2 to the solid content contained in the coating liquid was 2.2 mass %. At this time, the amount of moisture contained in the solution of the binder was 279 ppm by mass. The amount of moisture contained in the positive electrode material mixture layer was 179 μg/cm³, and the density of the positive electrode material mixture layer was 3.4 g/cm³.

### Example 4

A positive electrode was obtained in the same manner as in Example 3 except that a mixture of 60 mass % of lithium nickel manganese cobalt oxide single particles having a Ni content of 84 at. % and a volume-based median diameter D₅₀ of 5 μm and 40 mass % of lithium nickel manganese cobalt oxide single particles having a Ni content of 84 at. % and a volume-based median diameter D₅₀ of 2 μm was used as the positive electrode active material. At this time, the amount of moisture contained in the solution of the binder was 277 ppm by mass. The amount of moisture contained in the positive electrode material mixture layer was 188 μg/cm³, and the density of the positive electrode material mixture layer was 3.4 g/cm³.

### Example 5

A positive electrode was obtained in the same manner as in Example 3 except that the ratios of the binder and the conductivity aid 2 to the solid content contained in the coating liquid were 0.7 mass % and 1.8 mass %, respectively. At this time, the amount of moisture contained in the solution of the binder was 278 ppm by mass. The amount of moisture contained in the positive electrode material mixture layer was 172 μg/cm³, and the density of the positive electrode material mixture layer was 3.4 g/cm³.

### Example 6

A positive electrode was obtained in the same manner as in Example 3 except that the ratios of the binder and the conductivity aid 2 to the solid content contained in the coating liquid were 0.6 mass % and 1.9 mass %, respectively. At this time, the amount of moisture contained in the solution of the binder was 277 ppm by mass. The amount of moisture contained in the positive electrode material mixture layer was 171 μg/cm³, and the density of the positive electrode material mixture layer was 3.4 g/cm³.

### Comparative Example 1

A positive electrode was obtained in the same manner as in Example 2 except that the dew point of the environment was changed to −10° C. and the ratio of the conductivity aid 1 to the solid content contained in the coating liquid was 2.2 mass %. At this time, the amount of moisture contained in the solution of the binder was 289 ppm by mass. The amount of moisture contained in the positive electrode material mixture layer was 862 μg/cm³, and the density of the positive electrode material mixture layer was 3.5 g/cm³.

### Comparative Example 2

A positive electrode was obtained in the same manner as in Comparative Example 1 except that the dew point of the environment was changed to −20° C. At this time, the amount of moisture contained in the solution of the binder was 260 ppm by mass. The amount of moisture contained in the positive electrode material mixture layer was 331 μg/cm³, and the density of the positive electrode material mixture layer was 3.4 g/cm³.

### (Preparation of Cell)

Lithium bis(fluorosulfonyl)imide (LiFSI) as an electrolyte corresponding to 2.1 mol/L, a mixed liquid of 1,2-dimethoxyethane (DME) and 1,1,2,2-tetrafluoroethyl-2,2,3,3-tetrafluoropropyl ether (TTE) in a molar ratio of 3:2 as a solvent, and lithium difluoro (oxalate) borate (LiDFOB) as an additive corresponding to 0.5 mass % were mixed, to obtain an electrolytic solution.

A clad material was prepared by bonding a copper foil having a thickness of 10 μm and an electrical conductivity of 6.5×10⁶ S/cm as a negative electrode current collector and a lithium foil having a thickness of 20 μm. The clad material was punched out into a size of 34 mm×44 mm to obtain a negative electrode.

A positive electrode, an Al₂O₃-coated polyethylene porous film serving as a separator, and a negative electrode were laminated and housed in a laminate case. An electrolytic solution was then poured into the laminate case, and the laminate case was sealed to obtain a cell (lithium metal secondary battery cell).

### (Initial Capacity of Cell)

Using a Charge-Discharge Test System TOSCAT-3000S (manufactured by Toyo System Co., Ltd.) and a lightspec thermostat LU-124 (manufactured by ESPEC CORP.), the cell was charged to 4.30 V at a constant current of 16.83 mA in an environment at a temperature of 25° C., and then charged at a constant voltage of 4.30 V for 1.5 hours and left for 10 minutes. Subsequently, the cell was discharged to 2.65 V at a constant current of 16.83 mA and left for 30 minutes. The above operation was repeated twice to charge and discharge the cell, and the initial capacity of the cell was measured. The current value at which the discharge of the obtained discharge capacity can be completed in one hour was defined as 1 C.

### (Capacity Retention Ratio of Cell)

Using a Charge-Discharge Test System TOSCAT-3000S (manufactured by Toyo System Co., Ltd.) and a lightspec thermostat LU-124 (manufactured by ESPEC CORP.), the cell was charged to 4.3 V at a constant current of 0.33 C in an environment at a temperature of 25° C., left for 10 minutes, then discharged to 3.00 V at a constant current of 0.33 C, and left for 30 minutes, and the operation was repeated 48 times to charge and discharge the cell. Subsequently, the operation described in section (Initial Capacity of Cell) was repeated twice to charge and discharge the cell, and the capacity of the cell after charging and discharging was measured. Then, using the equation:

$$( capacity of cell after charging and discharging ) \text{} \text{/} ( initial capacity of cell ) \times 100 ,$$

the capacity retention ratio of the cell was calculated.
(Amount of Gas Generated after Charging and Discharging)

50 charging and discharging operations under the same conditions as in section (Capacity Retention Ratio of Cell) were performed twice, and then the amount of gas generated was measured using an Electronic Densimeter MDS-3000 (manufactured by Alpha Mirage Co., Ltd.).

Table 1 shows the characteristics and evaluation results of the positive electrode.

TABLE 1

| | | | | | | | | Comparative | Comparative |
|---|---|---|---|---|---|---|---|---|---|
| | | Example1 | Example2 | Example3 | Example4 | Example5 | Example6 | Example1 | Example2 |
| Environment | Dew | −50 | −50 | −50 | −50 | −50 | −50 | −10 | −20 |
| | point(° C.) | | | | | | | | |
| Positive electrode | Ni content | 84 | 84 | 84 | 84 | 84 | 84 | 84 | 84 |
| active material | (at. %) | | | | | | | | |
| First single | D₅₀(μm) | 5 | 5 | 5 | 5 | 5 | 5 | 5 | 5 |
| particle | Ratio | 100 | 70 | 70 | 60 | 70 | 70 | 70 | 70 |
| | (mass %) | | | | | | | | |
| Second single | D₅₀(μm) | — | 2 | 2 | 2 | 2 | 2 | 2 | 2 |
| particle | Ratio | — | 30 | 30 | 40 | 30 | 30 | 30 | 30 |
| | (mass %) | | | | | | | | |
| Conductivity aid | Type | 1 | 1 | 2 | 2 | 2 | 2 | 1 | 1 |
| | Content | 3.0 | 1.2 | 2.2 | 2.2 | 1.8 | 1.9 | 2.2 | 2.2 |
| | (mass %) | | | | | | | | |
| Binder | Content | 0.8 | 0.8 | 0.8 | 0.8 | 0.7 | 0.6 | 0.8 | 0.8 |
| | (mass %) | | | | | | | | |
| Solution | Amount of | 264 | 278 | 279 | 277 | 278 | 277 | 289 | 260 |
| of binder | moisture | | | | | | | | |
| | (ppm) | | | | | | | | |
| Positive electrode | Amount of | 157 | 156 | 179 | 188 | 172 | 171 | 862 | 331 |
| material mixture | moisture | | | | | | | | |
| layer | (μg/cm²) | | | | | | | | |
| | Density | 3.3 | 3.5 | 3.4 | 3.4 | 3.4 | 3.4 | 3.5 | 3.4 |
| | (g/cm²) | | | | | | | | |
| | Crack | A | A | A | A | A | A | A | A |
| Positive electrode | Volume | 10.0 | 4.7 | 3.8 | 4.0 | 4.2 | 4.3 | 52.1 | 40.3 |
| | resistivity | | | | | | | | |
| | (Ω · cm) | | | | | | | | |
| | Peel | 6 | 21 | 24 | 20 | 8 | 6 | 5 | 4 |
| | strength(N/m) | | | | | | | | |
| Cell | Initial | 44 | 52 | 52 | 52 | 52 | 52 | 52 | 52 |
| | capacity (mAb) | | | | | | | | |
| | Capacity | 99.5 | 98.0 | 99.0 | 98.6 | 98.2 | 98.3 | 96.6 | 96.1 |
| | retention | | | | | | | | |
| | ratio(%) | | | | | | | | |
| | Amount of gas | 20 | 4.2 | 4.6 | 7.9 | 4.3 | 5.1 | 79 | 77 |
| | generated after | | | | | | | | |
| | charging and | | | | | | | | |
| | discharging (mL) | | | | | | | | |

From Table 1, it can be seen that the positive electrodes of Examples 1 to 6 each maintain the peel strength even when the content of the binder is small, the amount of gas generated after charging and discharging of the cell is small, and the capacity retention ratio of the cell is high. In contrast, in the positive electrode of Comparative Example 1, since the amount of moisture contained in the solution of the binder is 289 ppm by mass and the amount of moisture contained in the positive electrode material mixture layer is 862 μg/cm³, when the content of the binder is reduced, the peel strength is not maintained, the amount of gas generated after charging and discharging the cell is large, and the capacity retention ratio of the cell is low. In the positive electrode of Comparative Example 2, since the amount of moisture contained in the positive electrode material mixture layer is 331 μg/cm³, when the content of the binder is reduced, the peel strength is not maintained, the amount of gas generated after charging and discharging the cell was large, and the capacity retention ratio of the cell is low.

What is claimed is:

1. A method for producing a positive electrode, the method comprising:
mixing a positive electrode active material and a solution of a binder to produce a coating liquid; and
applying the coating liquid to a positive electrode current collector to form a positive electrode material mixture layer,
wherein the positive electrode active material comprises single particles having a Ni content of 80 at. % or more,
wherein an amount of moisture contained in the solution of the binder is 280 ppm by mass or less,
wherein a ratio of the binder to a solid content contained in the coating liquid is 1 mass % or less, and
wherein an amount of moisture contained in the positive electrode material mixture layer is 200 μg/cm³ or less.

2. The method for producing a positive electrode according to claim 1, wherein the positive electrode active material comprises first single particles having a volume-based median diameter D₅₀ of 3 μm or more and 5.5 μm or less.

3. The method for producing a positive electrode according to claim 2, wherein the positive electrode active material further comprises second single particles having a volume-based median diameter D₅₀ of 0.5 μm or more and 2.5 μm or less.

4. The method for producing a positive electrode according to claim 3, wherein in the positive electrode active material, a mass ratio of the second single particles to the first single particles is 1/9 or more and 3/2 or less.

5. The method for producing a positive electrode according to claim 1, wherein the ratio of the binder to the solid content contained in the coating liquid is 0.5 mass % or more and 0.8 mass % or less.

6. The method for producing a positive electrode according to claim 1,
wherein when producing the coating liquid, a conductivity aid is further mixed therein, and
wherein a ratio of the conductivity aid to the solid content contained in the coating liquid is 2.5 mass % or less.

7. The method for producing a positive electrode according to claim 6, wherein the ratio of the conductivity aid to the solid content contained in the coating liquid is 2.0 mass % or less.

8. A positive electrode comprising:
a positive electrode current collector; and a positive electrode material mixture layer formed on the positive electrode current collector,
wherein the positive electrode material mixture layer comprises a positive electrode active material and a binder, and a content of the binder is 1 mass % or less,
wherein the positive electrode active material comprises single particles having a Ni content of 80 at. % or more, and
wherein an amount of moisture contained in the positive electrode material mixture layer is 200 μg/cm³ or less.

9. The positive electrode according to claim 8, wherein the positive electrode material mixture layer has no pores having a major axis of 3 μm or more.

10. The positive electrode according to claim 8,
wherein the positive electrode material mixture layer further comprises a conductivity aid, has a content of the conductivity aid of 2.5 mass % or less, and has a density of 3.2 g/cm³ or more and 3.6 g/cm³ or less, and
wherein the positive electrode has a volume resistivity of 5.0 Ω·cm or less.

11. The positive electrode according to claim 10, wherein the positive electrode material mixture layer has a content of the conductivity aid of 2.0 mass % or less.

12. The positive electrode according to claim 11, wherein the positive electrode active material comprises first single particles having a volume-based median diameter D₅₀ of 3 μm or more and 5.5 μm or less and second single particles having a volume-based median diameter D₅₀ of 0.5 μm or more and 2.5 μm or less.

13. The positive electrode according to claim 12, wherein in the positive electrode active material, a mass ratio of the second single particles to the first single particles is 1/9 or more and 3/2 or less.

14. A lithium metal secondary battery comprising the positive electrode according to claim 8.
